(19) United States
(12) Patent Application Publication
(10) Pub. No.: US 2014/0279544 A1
(43) Pub. Date: Sep. 18, 2014

(54) CREATION AND USE OF MOBILE IDENTITIES

(71) Applicant: INDEPENDENCE BANCSHARES, INC., Greenville, SC (US)

(72) Inventors: Gordon BAIRD, Darien, CT (US); Humphrey CHEN, Palisades Park, NJ (US); Aditya KHURJEKAR, Basking Ridge, NJ (US)

(73) Assignee: INDEPENDENCE BANCSHARES, INC., Greenville, SC (US)

(21) Appl. No.: 14/215,664

(22) Filed: Mar. 17, 2014

Related U.S. Application Data
(60) Provisional application No. 61/791,981, filed on Mar. 15, 2013.

(51) Int. Cl. G06Q 20/40; G06Q 50/00

(52) U.S. Cl. CPC G06Q 20/4014; G06Q 50/01
USPC 705/44

(57) ABSTRACT

Exemplary embodiments provide methods, mediums, and systems for generating and applying an electronic identity. The electronic identity may allow an individual's electronic or online presence to be secured and verified, thereby providing increased levels of trust in the identity of the individual. The electronic identity may correlate data from multiple different sources, including social networks, career websites, online marketplaces, financial institutions, and the individual. Based on the amount of data that can be verified or correlated with other data, a trust score may be assigned to the electronic identity. The electronic identity may be used to verify an individual's identity for various purposes, such as obtaining a financial account, obtaining identification, performing transactions, and social interactions.

### RELATED APPLICATIONS

This application claims priority to U.S. Provisional Patent Application Ser. No. 61/791,981, entitled “Methods, Systems, and Mediums for Supporting Mobile Payments” and filed on Mar. 15, 2013. The contents of the aforementioned application are incorporated herein by reference

### BACKGROUND

Increasingly, consumers are relying upon computer networks, such as the Internet, as well as mobile devices, to engage in commerce and social activities. In conjunction with this trend, there has been a rise in the electronic movement of funds and the use of electronic forms of currency, as well the sharing of personal information across networks. This has resulted in a number of problems and opportunities.

For example, it may be difficult to verify the identity of an entity attempting to move funds, transfer currency, or access personal information. Some entities may be subject to impersonation, making it extremely important to verify that a particular entity is who they say they are prior to authorizing a transfer of funds of data from the entity's account. Current authentication schemes may be cumbersome and/or prone to problems of impersonation (e.g., by stealing or guessing a user's password). Thus, there is a need for a secure and efficient electronic form of “identity” to ensure that an entity is who they purport to be.

Still further, the use of mobile devices and social networks to conduct commerce and interact with others on the Internet provides unique opportunities in such fields as authentication and the evaluation of creditworthiness. However, online services and banks currently do not take advantage of these opportunities.

The present application addresses solutions to these and other problems of electronic commerce, currency, and social interaction.

### SUMMARY

Exemplary embodiments provide methods, mediums, and systems for generating and applying an electronic identity. The electronic identity may allow an individual's electronic or online presence to be secured and verified, thereby providing increased levels of trust in the identity of the individual. The electronic identity may correlate data from multiple different sources, including social networks, career websites, online marketplaces, financial institutions, and the individual. Based on the amount of data that can be verified or correlated with other data, a trust score may be assigned to the electronic identity. The electronic identity may be used to verify an individual's identity for various purposes, such as obtaining a financial account, obtaining identification, performing transactions, and social interactions.

According to an exemplary embodiment, a request to create a profile of a subscriber may be received. Based on the request, an identity agent may obtain information from the subscriber, and supplement the obtained information with additional information obtained from multiple different sources. The additional information may pertain to a multiple different categories of information of the subscriber. The additional information may be, for example, mobile device information retrieved from a mobile device of the subscriber, social network information retrieved from a social network account of the subscriber, or electronic marketplace information retrieved from an electronic marketplace account of the subscriber.

The obtained information and the additional information may be stored together in a storage medium to create an electronic identity structure. The obtained information and the additional information may be correlated to determine a trustworthiness of the electronic identity structure.

Among other items, the electronic identity structure may include a virtual currency flag indicating whether the subscriber is authorized to engage in transactions involving virtual currencies.

Upon request by a requesting entity, either (or both of) a copy of the electronic identity structure or a measurement of the trustworthiness may be provided to the requesting entity.

A transaction may be performed by the subscriber, and an indication of the transaction may be provided to the identity agent. The electronic identity structure may be updated with information about the transaction.

In some embodiments, the request to create the profile of the subscriber may be received from a requesting entity that requests to perform a transaction with the subscriber. The additional information may be obtained from a related entity that takes part in the transaction, or from an unrelated entity that does not take part in the transaction.

According to exemplary embodiments, financial information may be retrieved from the electronic identity structure. A credit score may be calculated from the financial information. Alternatively or in addition, risk information may be retrieved from the electronic identity structure, and an insurance risk may be calculated from the risk information.

In some embodiments, the identity agent or a third party may issue an insurance policy for guaranteeing the subscriber's identity. A cost of the insurance policy may be determined, at least in part based, on the calculated trustworthiness of the electronic identity structure.

According to another exemplary embodiment, personal information about a subscriber may be retrieved and organized into a hierarchy including a first tier of personal information and a second tier of personal information. In some embodiments, a rule may be assigned to the second tier of personal information. The rule may include a condition under which the personal information is shareable.

The first tier of information may be provided to a requestor. For example, the first tier of information may be broadcast and received by the requestor.

The requestor may submit a request from the requestor to access the second tier of personal information. Based on the request, an electronic identity or an electronic identity verification score may be retrieved from the requestor. The electronic identity verification score may be calculated based on an amount of information in the electronic identity which is verified or correlated with other information in the electronic identity.

The electronic identity or electronic identity verification score may be evaluated to determine whether to provide the second tier of personal information to the requestor. For example, the electronic identity or electronic identity verification score of the requestor may be compared to the condition in the rule.

In an exemplary embodiment, a beacon may be activated to indicate that the first tier of personal information is available for inspection.

In some embodiments, the personal information may be personal information associated with a social network account, and an amount of the personal information revealed to the requestor varies with the electronic identity verification score.

According to another exemplary embodiment, personal information about a subscriber may be retrieved, along with authorized device information associated with one or more of the subscriber's mobile devices, account information associated with one or more transaction accounts of the subscriber, geographical information pertaining to the subscriber, and chronology information pertaining to the subscriber. The personal information, the authorized device information, the account information, the geographical information, and the chronology information may be assembled into an electronic identity file. A virtual currency flag may be added to the electronic identity file to indicate whether the subscriber is authorized to conduct transactions involving a virtual currency. In some embodiments, the electronic identity file may further include social network information that includes information retrieved from a social network with which the subscriber has an account.

The exemplary embodiments will be described in more detail with respect to the Figures discussed below.

### BRIEF DESCRIPTION OF THE DRAWINGS

FIG. 1 depicts an exemplary environment for providing information used in the generation and maintenance of electronic identities.

FIG. 2A depicts a flowchart describing an exemplary process for generating an electronic identity.

FIG. 2B depicts a flowchart describing an exemplary process for generating an electronic identity based on social network data.

FIG. 3 depicts a flowchart describing an exemplary application of electronic identities for social interactions.

FIG. 4 depicts an exemplary data structure for storing an electronic identity according to an exemplary embodiment.

FIG. 5 depicts an electronic device suitable for use with exemplary embodiments described herein.

### DETAILED DESCRIPTION

### Terms and General Notes

Unless otherwise noted, the following terms are used herein with the following meanings:

A typical environment involving the transfer of electronic currency (e.g., for micropayments) includes a Sender, e.g. the entity that provides the value (money, currency, funds or other tangible units of value); a Receiver, e.g. the entity that receives the value; a Sending Agent, e.g. the entity that facilitates the sending of value on behalf of the Sender; a Receiving Agent, e.g. the entity that facilitates the receiving of value on behalf of the Receiver; the Provider, e.g. the administrator of the Exchange, which may be a clearinghouse, marketplace, aggregator or overall facilitator of such a service. The Provider is often expected to be an authorized financial institution.

In the context of authentication and/or identification, the individual whose identity is being established (e.g., the primary user under consideration) is referred to as Subscriber, distinct from other users who may also be part of the method or system. The established identity is referred to herein as a mobile identity or mIdentity. The establishment of an mIdentity may begin when a user attempts to initiate a relationship or a transaction that is enabled or managed by an authorized financial institution (which may be a Provider), even though the account or transaction may be distributed by another entity (a Beneficiary of an mIdentity). The Provider may be typically a bank, while the Beneficiary can be any business entity or individual who needs to establish the mIdentity of Subscriber. Other entities who may provide information that creates or modifies mIdentity, as managed by the Provider, will be referred to as a Source or Sources.

As used herein, an Open Loop Network is a multi-party network that connects two or more financial institutions for carrying out financial transactions. Payments for goods and services in an open loop network are typically managed by the connected financial institutions (usually a first financial institution that issues credit to a customer, and a second financial institution that is associated with a merchant). Visa and MasterCard are examples of open loop networks. In contrast, a Closed Loop Network is a network in which payments are made directly by the owner of the network (e.g., a merchant that issues a private-label credit card to its customers, or a merchant that issues a specialized currency such as Disney Dollars).

As used herein, micropayments are financial transactions, usually of small value, between many distinct senders and receivers, and usually large in number and with a high frequency of occurrence.

As used herein, a currency may be a physical currency, a currency issued by a state entity, and/or a virtual currency such as BitCoin.

Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

No element, act, or instruction used in the description of the invention should be construed critical or essential to the invention unless explicitly described as such. It is intended that the invention not be limited to the particular embodiments disclosed above, but that the invention will include any and all particular embodiments and equivalents falling within the scope of the description herein.

### Contextual Material

As noted above, exemplary embodiments described herein relate to mobile identities. In some embodiments, these mobile identities may be used in conjunction with mobile currency transactions—for example, in order to verify the identities of parties to a mobile transaction. Examples of processes and systems for performing mobile transactions are described in U.S. patent application Ser. No. 14/212,556 entitled Mobile Currency Messaging Systems (attorney docket no. IBW-001), filed Mar. 14, 2014. The contents of this application are incorporated herein by reference.

Furthermore, the mobile identities described herein may be used in conjunction with a transaction system, routing protocols, and interfaces (such as Application Programming Interfaces, or “APIs”). Examples of such systems, protocols, and interfaces are described in U.S. patent application Ser. No. <NUMBER> entitled Methods and Systems for Executing Mobile Currency Transactions (attorney docket no. IBW-003), filed Mar. 17, 2014. The contents of this application are incorporated herein by reference.

### Exemplary Embodiments

Exemplary embodiments generally relate to the field of identity and security, primarily in (but not limited to) the field of financial transactions and social networking.

The proliferation of user interactions with the Internet, especially by mobile devices, allow for more accurate identification of a particular user in the context of a financial transaction. The financial transaction itself adds to the set of available interactions for the user to establish the user's identity for subsequent financial or non-financial transactions on a connected device. Exemplary embodiments describe the secure and regulatory-compliant compilation of these digital user touch-points into a consolidated identity that allows a receiver of such a derived “mIdentity” to conduct business with the user associated with the mIdentity with a higher degree of validation.

Numerous personally-identifiable services exist both online and offline. Examples include, but are not limited to, signing up for a telephone line, opening a bank account, applying for a passport, updating a shared web-site, sending or receiving money digitally, etc.

In order to protect the integrity of such personally-identifiable services, a user of these services may establish an identity with the provider of the service, or with a counter-party to the transaction. To reduce the possibility of fraud in identifying the user before any such service is consummated, the provider of the service (or the provider of the system that enables the service) may rely on certain information related to that service to establish the identity of the user. Conventionally, processes of establishing identity are disparate and disjointed, even though the same user may be availing of these different services and some of the information in establishing these service-specific identities might be the same or similar.

Thus, numerous services require the establishment of some sort of identity for a user before the user can consummate a transaction with the service. A careful, secure, and legal amalgamation of these various sources of identity, across different service providers, yet all relating to the same user, may result in an identity that is far more accurate than any of them individually. For example, an identity may be established using a combination of bank account depository information, mobile connected device digital footprint and user supplied inputs.

Exemplary embodiments describe the creation and use of such a user identity.

As shown in FIG. 1, a subscriber 110 may wish to establish an mIdentity. The subscriber 110 may interact with multiple sources that may provide information useful for the establishment of such an identity.

For example, the subscriber 110 may interact with a subscriber mobile device 120, such as a tablet, smartphone, laptop computer, etc. The subscriber mobile device 120 may be used to carry out a number of the subscriber's 110 financial transactions (e.g., making online purchases, requesting balance transfers or inquiries from a bank, etc.) or social network interactions, each of which may contain relevant information about the subscriber 110. Further, the subscriber mobile device 120 may itself contain identifying information, such as a serial number, MAC address, SIM card number, geolocation data, etc. Because the subscriber mobile device 120 is used by the subscriber 110, this device identifying information may be used as a proxy for identifying the subscriber 110.

The subscriber mobile device 120 may be serviced by a mobile carrier 130. The mobile carrier 130 may have information about the subscriber 110, such as account information, a list of linked family accounts, location information for the subscriber, address data for the subscriber, etc.

The subscriber may use the subscriber mobile device 120 (or another electronic device) to interact with one or more social networks, online marketplaces, academic or business websites, etc. The subscriber's 110 online presence 140 may include a great deal of personal information, such as the city in which the subscriber 110 is located, the subscriber's 110 academic or employment history, places that the subscriber 110 has visited, relatives of the subscriber 110, etc.

The subscriber may interact with yet other sources 150 of personal information, such as a bank, a credit reporting agency, a car dealership, a library, a doctor's office, etc. These sources might include beneficiaries 160, which may include entities that receive value from the subscriber 110. For example, the beneficiaries may include merchants from whom the beneficiary has purchased goods, or clients for whom the beneficiary has provided services.

Another potential source of personal information may be the subscriber's 110 insurance provider 170. The insurance provider may have basic personal demographic information about the subscriber 110, and may supplement this personal information with information pertaining to the behaviors and/or risks incurred by the subscriber 110.

The subscriber 110 may request that an identity agent 180 create an mIdentity for the subscriber 110. The identity agent 180 may receive authorization from the subscriber to retrieve personal data from one or more sources of information 120-170. The identity agent 180 may retrieve this personal data from the sources and may attempt to correlate information found in the different sources (e.g., each of the subscriber's mobile carrier 130, insurance provider 170, and social networks/online presence 140 may contain information about the subscriber's home address). The more the different sources of information can be validated and/or correlated, the more confidence the identity agent 180 may have that the subscriber's mIdentity is accurate.

An exemplary process for generating and managing such an mIdentity is depicted in FIG. 2A.

At step 210, the identity agent may create an initial profile for the subscriber. This step may be initiated by the Subscriber, the identity agent, a source of personal information for the subscriber, or a beneficiary associated with the subscriber. The initial profile may be empty, or may contain any information about the subscriber that was associated with the request to create the initial profile.

At step 212, the identity agent may obtain basic identity/demographic information from the Subscriber, such as name, address, date of birth, etc. The identity agent may acquire this information through direct contact with the subscriber and/or may obtain this information from one or more of the sources of information depicted in FIG. 1.

At step 214, the identity agent may request to connect to the subscriber's mobile device. If the subscriber submitted the initial request to create the mIdentity to the identity agent through the mobile device, then the identity agent may access the mobile device through the already-established connection. The identity agent may record information related to the characteristics of that device, the location of that device, the connectivity of that device, parameters that enable the connectivity of that device, and other sources of information related to the device. Step 214 may also involve connecting to the subscriber's mobile carrier. The information from the device and/or mobile carrier may be integrated into the initial profile to enhance the mIdentity for the subscriber.

At step 216, a beneficiary or source who already has a relationship with the subscriber and/or who is related to the original reason for the creation of the mIdentity may provide additional information to the identity agent. For example, the subscriber may be requesting the creation of the mIdentity as a prerequisite for performing transactions with a beneficiary (e.g., an online marketplace). The related beneficiaries and/or sources of information consulted at step 216 may include the beneficiary themselves and any entities related to the beneficiary that have a relationship with the subscriber. For example, if the subscriber provides the beneficiary with credit card information as part of the enrollment process, the identity agent may discover this information during step 216 and consult the credit card company for further information about the subscriber.

The beneficiary or source may provide this information in response to a request from the identity agent and/or under authorization by the subscriber. Such information may be integrated into the subscriber's profile to further enhance the mIdentity of the subscriber.

In addition to the beneficiaries and subscribers that are related to the reason for the creation of the mIdentity, at step 218 the identity agent may further consult other sources that are unrelated to the creation of the mIdentity. For example, the identity agent may consult a credit reporting agency, government records, social networks, etc. for information about the subscriber. This information may be integrated into the subscriber's profile to further enhance the mIdentity of the subscriber.

At step 230, the identity agent may optionally correlate the gathered information and generate the subscriber's mIdentity. Step 230 may involve the creation of a file or data structure, such as a digital identity file (described in more detail with respect to FIG. 4, below). The information in the file or data structure from various sources may be checked against information from other sources to ensure that the information is consistent. If the information is not consistent, the identity agent may attempt to verify the data, eliminate incorrect data, or flag or otherwise indicate that certain data appears to be untrustworthy.

After the mIdentity has been initially created, the identity agent may determine at step 222 whether the subscriber has initiated any recent transactions with previously-consulted or new sources. If the answer at step 222 is “YES,” then the identity agent may return to step 216 and collect further information about the subscriber's identity from these sources. Examples of such information include amount and location of purchases made with a debit card held at a Provider (which may be the identity agent), addition or deletion of joint account holders, redemption of offers or coupons associated to the account held with the Provider, etc.

If the answer at step 222 is “NO,” then processing may proceed to step 224, where the identity agent determines if there are any outstanding requests to access the subscriber's mIdentity. For example, the subscriber may have initiated a transaction with a beneficiary that requests verification by the provision of the mIdentity. If so, processing may proceed to step 226, where the subscriber may be asked for approval to provide the mIdentity to the beneficiary.

If the subscriber indicates approval at step 226, the identity agent may provide the mIdentity to the requesting beneficiary at step 228, which may result in a new transaction taking place. Accordingly, processing may return to step 222 to determine if new information has resulted from the new transaction.

Alternatively or in addition to providing the requestor with the subscriber's mIdentity, the identity agent may use the mIdentity to calculate the subscriber's “creditworthiness.” The information in the mIdentity may include a information about the subscriber's purchase and payment history, employment, risk factors, etc., and hence may provide a great deal of information relevant to the calculation of a credit score. This calculated score may be a numerical quantity, a logical value, or a recommended action based on the Subscriber's mIdentity.

Alternatively or in addition, the mIdentity may be used to determine, evaluate, and/or provide a calculation of insurance risk. Insurance companies often underwrite risks that are closely associated with the above-described information. For example, the mIdentity may contain geolocation information, which could be used to indicate if the subscribers spends time in high-crime areas (or even on a beach, where the user might be susceptible to losing their phone, having it stolen, or having it damaged by water or sand). The mIdentity may include transaction data, which could indicate if the subscriber sends money in multiple currencies or to multiple countries (or certain “high-risk” countries), which might indicate a susceptibility to currency fluctuations or the performance of illegal activities. Phone records may indicate if the subscriber is often out late at night

Using the above-described data sources and algorithms (similar to the credit score calculation described above), such an insurance risk may be more accurately, efficiently, and securely calculated. Accordingly, a “price” value for the risk may be determined and used in insurance underwriting.

If the subscriber refuses to provide approval at step 226, processing may proceed to step 230 where a termination message may be sent to the requesting beneficiary. The termination message may indicate that the subscriber has not provided approval for the beneficiary to receive the subscriber's mIdentity. Processing may then return to step 222 to await a new transaction, to step 234 to determine whether any additional outstanding requests for the subscriber's mIdentity are awaiting action, or to step 232 where processing may terminate.

If it is determined at step 224 that no outstanding requests for the subscriber's mIdentity are awaiting action, then processing may proceed to step 234. At step 234, the identity agent may determine whether the subscriber's mIdentity is due to be updated. The subscriber's mIdentity may be updated at regular or irregular intervals and/or after predetermined periods of time in order to account for new or changed information in the mIdentity. Examples of such information include changes in income, changes in family members, changes in marital status, changes in preferences or specific personal information that might have previously been estimated by the identity agent.

The update period may be dynamic, depending on the state of the subscriber's transactions. For example, the identity agent may be able to determine, based on the information obtained from the various sources, that the subscriber currently appears to be in the process of purchasing a home. Because of this, it is likely that much of the information in the mIdentity may change in a short period of time (e.g., the subscriber's home address may be updated, the subscriber may gain a new loan account for a mortgage, the subscriber's credit score may change, etc.). Thus, the update period may be set to a short amount of time in order to capture this information as it becomes available. On the other hand, if the information retrieved from the sources indicates that the subscriber executes few transactions over large periods of time, the identity agent may set the update period to a longer amount of time.

If the identity agent determines at step 234 that the subscriber's mIdentity is due to be updated, then processing may return to step 212 where the identity agent may start the information collection process anew (alternatively, processing may return to step 214 in order to avoid repeatedly prompting the user for demographic information which is unlikely to change very often). Otherwise, processing may proceed to step 232 and terminate.

The process described n FIG. 2A is intended to be exemplary. The protocol for creating, managing and sharing the mIdentity may be established by the identity agent in compliance with appropriate laws using secure technologies.

As part of, or as an alternative to, the information gathering process described above, in some embodiments the mIdentity may be strongly focused on the subscriber's online presence. This may be particularly useful for individuals who cannot, or do not wish to, obtain a government-issued identification card.

Although government issued identities are the market standard for verifying one's legal identity in any country or state, most governments continue to focus on the issuance of forge resistant physical ID cards while resisting digital implementations (which may be viewed as being too easy to manipulate or forge). Exemplary embodiments provide a different approach that resolves ones identity and issues a score based on how comprehensive, triangulate-able and consistent one's digital social trails are over an extended period of time.

Each major social network contains self-shared profile information which independently is triangulate-able with members from the respective communities. For instance, a high school or home town can easily be triangulated with other “friends” who also list that high school. This applies to colleges, graduate schools, family members employers, and other demographic information.

Within respective social communities (e.g., Facebook, Instagram, Google+) one type of deep and verifiable digital fingerprint can be calculated. For another type of network, (e.g., professional networking sites such as LinkedIn), one's academic and work history can be positively correlated back to the social profile to boost the score even further. In the case of purchasing sites such as eBay, one's purchasing and selling history serves to highlight the accuracy of presentation and follow-through when interacting with strangers. Similarly, one's Twitter stream represents the types of thoughts which the user has chosen to publicly air.

When profiles from multiple sites (e.g., Facebook, LinkedIn, Twitter, and eBay) are triangulated against each other and analyzed for accuracy and consistency a “Verifiable Social Identity Score” (VSIS) may be generated. The VSIS may represent a “fingerprint” for the user that corresponds to, for example, a mathematical representation of the user's social networking site identifying information, correlated across multiple social networking sites.

FIG. 2B depicts a process for calculating a VSIS according to an exemplary embodiment.

At step 250, information about the subscriber may be obtained from a first social network. The information may include basic demographic information such as name, age, gender, place of residence, place of employment, and the subscriber's friends list. The information may be obtained with the authorization of the subscriber.

At step 252, the identity agent may determine whether additional social networks should be consulted. The identity agent may automatically inspect popular social networking sites to determine whether the subscriber is a member of the site, or may ask the subscriber to provide a list of sites of which the subscriber is a member. If the answer at step 252 is “YES,” then processing may return to step 250 and information may be retrieved from the additional social networking sites.

Once all relevant social networking sites have been consulted, processing may proceed to step 254 to determine whether any other sites or networks should be consulted. For example, the identity agent may consult academic sites, professional networking sites (such as LinkedIn), job search sites, and online marketplaces. As noted above, different types of sites may provide different types of information that may be used to enhance and build a comprehensive mIdentity.

If the answer at step 254 is “YES,” then processing may proceed to step 256 where the other sites or networks may be consulted. Relevant information may be retrieved from the other networks or sites. Processing may then return to step 254 to retrieve information from as many sites as are deemed relevant.

Once the relevant sites have been consulted, at step 258 the identity agent may correlate the gathered information. For example, the identity agent may organize the information by category (e.g., demographic information, financial information, geographic information, interests and hobbies, etc.). Information within each category may be compared to ensure that it is valid and consistent.

Based on the correlation at step 258, at step 260 a score (e.g., a VSIS) may be calculated to represent the confidence in the data of the mIdentity. If some information appears to contradict other information, the score may be lowered. Alternatively, if multiple sources corroborate certain information, the score may be raised.

The different categories may be weighted in different manners depending on a type of score requested. For example, if the score is being used to verify a particular individual's identity before the individual opens a bank account, then information such as demographic data, employment data, and financial data may be weighted more than the subscriber's interests and hobbies. Multiple different types of scores using different weighting factors for different purposes may be calculated from the same mIdentity.

Optionally, at step 262, separate APIs may link the subscriber's mIdentity back to external databases, such as employer, academic, and government databases. These databases may be used to raise or lower the subscriber's score, when available.

Once calculated, the subscriber's VSIS may be used for a number of purposes. In one example, the VSIS (potentially in combination with the mIdentity) may govern how much information is available for inspection on a social network. For example, one of the problems regarding dating or networking sites such (or other online or even offline meeting areas) is that it is often difficult to ensure that the individuals with which a user communicates are who they purport to be. Many people use aliases in order to hide their true identity, which creates friction and fraud in the system, hindering the potential effectiveness of the attempted service.

Using the above-described VSIS, an individual may be provided with an option, using their mobile or digitally connected device, to “offer up” credentials to a person that provides a level of assurance that the user is who they purport to be. This may be performed through an online site, such as a dating site or social network, or in person (e.g., to prove that a nearby person that approaches the user to ask for a date is who they purport to be, or to assist the user in finding certain types of people in crowded environments like trade shows). FIG. 3 depicts an exemplary application of the above-described VSIS in such a context.

In brief overview, the process of FIG. 3 allows users to authenticate at different “levels,” and/or to request access to different levels of identity information from other users. For example, a basic “Level 1” set of personal information may be made freely available or may be made available to entities that have passed a basic level of authentication. The user may manually authorize, upon receiving a request for more information, other users to access more detailed “Level 2” information. Alternatively, the user may allow other users who have authenticated at a more rigorous or trusted level to receive Level 2 information. Still further, in another embodiment Level 1 information may be available to the general public, while only people meeting certain requirements (e.g., demographic, location-based, etc.) may receive Level 2 information.

Accordingly, a tiered hierarchy of personal information may be established and enabled/restricted based on user-approval and/or authentication levels. Information in the tiered hierarchy (and which tier of the hierarchy the information appears in) may be specified by the user, or may be specified by an entity through which the user requests the information (e.g., a dating web site or networking conference committee).

At step 310, the user may provide information to a networking site, dating site, or any other entity which collects and shares personal information. For example, the user may create a profile on a social network that includes multiple pieces of personal information.

At step 312, the user may organize the information into a hierarchy. For example, the user may be capable of tagging individual pieces of information with a “tier” of privacy protection. Basic information that the user wishes to freely share may be tagged as “tier 1 information,” while information to which the user wishes to restrict access may be tagged as “tier 2 information.” The user may specify further tiers to increase the granularity at which the information is shared (e.g., tier 1 information is to be shared with the general public, tier 2 information is to be shared with people in the same field of employment, tier 3 information is to be shared with people in a particular geographic area, etc.).

At step 314, the user may assign one or more rules to each of the tiers. The rules may specify a condition which an accessing entity must meet before information is shared, and a tier of information available if the condition is met. The conditions may be based on information in a requestor's mIdentity and/or the requestor's VSIS score.

For example, one rule may indicate that a user of a dating site must meet certain age, gender, and geographic restrictions before photographs on a dating profile are shared. Another rule might indicate that a user's employment history would only be shared with users of a professional networking site if the accessing user were in the same field of employment as the user. Yet another rule might specify that a user's geographic location information is only available to users who have been legitimated by having a VSIS score above a certain threshold.

At step 316, the user may optionally activate a beacon to indicate that their information is available for sharing, if the conditions of step 314 are met. For example, the user may indicate that no information is shared, or certain tiers of information are not shared, unless the beacon is active.

The beacon may be broadcast to nearby users and may serve as an invitation to request further information from the user that activated the beacon. For instance, consider a user that arrives at an annual trade show in Orlando. The user may be assigned the task of making at least 5 new contacts with new senior officers at some new prospective clients or vendors. However, the user may not know how to find these individuals because the user has never met them before.

Accordingly, the user may turn on a “networking beacon.” In order to turn on the beacon, the user may be prompted to enter, for example, a “conference ID” assigned to the user by the conference organizers or a third party network organization (e.g., LinkedIn). The conference ID may be used to authenticate the user as an authorized person on for the duration of the conference and/or at a geographical location (e.g., for a 3 day event on March 22, 23 and 24^{th}, taking place within 1 mile of the Venetian Hotel). At other times and/or locations, the beacon may not be visible.

Once the user has turned on the beacon and authenticated themselves for the location of the conference, the user's basic Level 1 data may be broadcasted to other “conference ID” authorized users. Level 1 Data may include, for example, a name, a professional/work title, a company for which the user works, and optionally a picture of the user.

Once the beacon is activated, the user may also be provided with an interface displaying a map of other people in the room and their Level 1 data. In one embodiment, the user may be presented with one or more lists that reports the Level 1 data of people that are within certain predefined geographic distances of the user—for example, within 1 meter, within 1-3 meters, and within 4-20 meters.

This information may be used to determine which individuals the user wishes to approach. In one embodiment, the interface may allow the map to be filtered based on Level 1 data (e.g., only people employed by a certain company may be displayed on the map). Alternatively, a search function may be provided allowing the user to search the other users who are nearby for parameters in the Level 1 data.

The activation of the beacon may be part of a condition for one of the aforementioned rules (e.g., a user might specify that only people within a 300 foot radius may be able to access the user's “Level 1” mIdentity information, and only when the beacon is turned on).

Alternatively or in addition, the visibility of the beacon may be restricted based on one or more conditions. In another example, the user may specify that only people who a) are registered in Kansas City as their home city and b) went to Michigan State can see the beacon when it is activated.

Based on the presence of the beacon (if the beacon was set in step 316), at step 318 the user's Tier 1 information may be broadcast to any other user's meeting the conditions for receiving Tier 1 information. In certain embodiments, Tier 1 information is freely available to all users. In another embodiment, Tier 1 information may be initially restricted from public visibility. In order to gain access to a particular user's Tier 1 information a requesting user may need to agree to share their own Tier 1 information with the user. After an authentication filter is applied, and both parties have agreed to be identifiable by each other to thereby authorize them to see each user's basic (e.g., Tier 1) data, then one party may request more detailed (e.g., Tier 2) information from the other individual. Examples of Tier 2 information may include the user's first name, address, or a “chat screen.”

At step 320, a request for the user's Tier 2 information may be received from a requestor. At step 322, the requestor's electronic identity (e.g., a file containing an mIdentity) and/or VSIS score may be retrieved.

At step 324, the mIdentity and/or VSIS score may be evaluated to determine whether to share the requested data. For example, the mIdentity and/or VSIS score may be checked against the rules defined at step 314 to determine whether the requestor meets the conditions for providing the Tier 2 data.

If the answer at step 324 is “YES,” then the requested Tier 2 data may be shared at step 326. In one embodiment, an interface may be provided for allowing the requestee to provide the requestor with the data (e.g., by “bumping” mobile phones or transmitting an electronic business card). In some embodiments, the requested data may be automatically transferred or made visible on the requestor's device.

If the answer at step 324 is “NO,” then an option may be provided for the requestee to manually approve the transfer of the information. The option for manual approval may be toggled on and off by the requestee so that the requestee is not presented with requests. If the requestee opts to manually approve the request, then processing may proceed to step 326, where the requested data may be shared.

If the answer at step 328 is “NO,” or if manual approval has not been enabled, then processing may proceed to step 330 where an optional message explaining the reason for the rejection is sent to the requestor. For example, the requestor may be informed that the requestor did not meet one or more requirements for retrieving the requested information, or that the requestor needs to improve their VSIS score by validating more details of their own information before the requested information can be shared.

Processing may then return to step 318, where Tier 1 information is broadcast and the system awaits further requests for Tier 2 information.

The process described in FIG. 3 is but one example of an application for the mIdentity and the VSIS score. Other exemplary uses for this data are briefly described below.

### Use Case 2: Automotive Identities

The identity of an automobile may be officially linked to the registration/title of the owner; however the owner is not always the driver. Current mechanisms for automotive identity and payment presentment involve license plate and RFID enabled tags such as “EZ-Pass” which are currently leveraged for expedited toll processing. When someone other than the legal owner drives the vehicle, they knowingly or unknowingly may incur payment fees/transactions/violations to the owner of the vehicle.

Exemplary embodiments make use of a user's mobile/smart phone to represent the identity of the driver and authorized payment instruments, which in turn are transmitted by the car so that both the legal owner and the identity of the driver are presented to drive-throughs/toll booths/gates, etc. for more complete and proper payment/responsibility attribution. Thus, a mobile/smart phone may be leveraged as a dynamic real-time identification engine which is utilized whenever a new mobile/smart phone is integrated/paired/tethered to the vehicle.

The mobile/smart phone may serve as the key/FOB for not only starting the automobile, but in this case to represent the identity of the driver and to represent billing/payment information. This payment information may be processed in real-time. In another embodiment, the mobile/smart phone may be used to gain access to secure/private/gated facilities. When the Mobile/Smartphone is paired, integrated or docked with the Automobile/Truck/Van/SUV/Motorcycle/Moped Telematics system, the in car telematics screens or Mobile/Smartphone screen is able to facilitate relayance of payment. Such payment may be used to pay for a food/beverage/e-menu order or a toll, for identity verification and re-verification, and/or for 2^{nd}/3^{rd} factor authentication.

### Use Case 3: Immigrant Identities

Immigrants to the United States occasionally find themselves without official recognized U.S. identities/forms of identification. As a result, it may be difficult or impossible to open a bank account or apply for credit.

However, these individuals may have valid forms of identification from other U.S. recognized governments that may be combined with other forms of social network identification in order to sufficiently validate that the individual is legitimate and warrants providing access to basic banking capabilities. This identity may be combined with a special-purpose insurance policy to provide the issuing bank with additional safeguards to protect against unanticipated risk exposure.

For example, international students arriving into the United States with temporary student visas to attend an accredited U.S. university would, using exemplary embodiments, be able to open a bank account given the financial instruments designed to accommodate full U.S. regulatory compliance, while also capping financial exposure to minimize risk. This type of approach allows banks to provide access to basic banking privileges that up until now would have been inaccessible to the under-banked/under-served part of the U.S. banking population.

### Electronic Identity Storage

As can be seen from the above, there are numerous potential applications for mIdentities and VSIS scores. In order to facilitate the use of these tools, exemplary embodiments also provide a standardized file format and encryption protocol to create a “Digital Identity File” (“DIF”). An exemplary file format is depicted in FIG. 4.

The DIF 400 may include an identifier for an encryption protocol 402. The DIF 400 may be encrypted according to the encryption protocol 402, and a system wishing to access the DIF 400 may retrieve the encryption protocol 402 from the DIF 400 and decrypt the DIF 400 (if the accessing system has the requisite authority and decryption keys).

The DIF 400 may further include a “poison pill” 404 that can be activated to cause the secure destruction of the DIF 400. The poison pill 404 may include instructions that are automatically carried out if the DIF 400 is accessed incorrectly, altered, or corrupted. The instructions may cause the DIF 400 to be securely deleted from a memory location in which the DIF 400 is stored.

The DIF 400 may include personal information 410, such as personal demographic information, about the subscriber for whom the DIF 400 was created. The personal information may include items such as the subscriber's name 412 (which may further be divided into a first name and a last name, each of which may be assigned different tiers of privacy protection), the subscriber's phone number 414, and the subscriber's home network ID 416.

The DIF 400 may further include identification information 420 for devices which the subscriber has authorized for use with an account associated with the DIF 400. For example, the authorized device information 420 may include a serial number 422 for a first mobile device (e.g., cell phone) used by the subscriber, a serial number 424 for a second mobile device (e.g., a tablet) used by the subscriber, etc.

The DIF 400 may include account information 430 for an account (e.g., a social network account, an online marketplace account, etc.) associated with the DIF 400. For example, the DIF 400 may include information about related accounts 432, such as a parent account (an account which has authorized the present account to carry out transactions) or child accounts (which are authorized to carry out transactions on behalf of the present account).

The account information 430 may further include a credit limit 434, which indicates an amount of credit which should be extended to the subscriber associated with the DIF when performing transactions. The account information 430 may include a payment limit 436 as well, which indicates a maximum amount of value that the subscriber of the DIF 400 is eligible to receive over a given period.

Furthermore, the account information 430 may include an online payment flag 438, indicating whether or not the account associated with the DIF 400 is allowed to perform online transactions.

The DIF 400 may include a list of allowed currency types 440 which can be used in accounts associated with the DIF 400. For example, the currency types 440 may include a cash flag 442, indicating whether or not the account is eligible to trade non-virtual (e.g., state-issued) currencies. Similarly, the DIF 400 may include a virtual currency flag 444, indicating whether or not the account is eligible to trade virtual currencies (e.g., BitCoin).

The DIF 400 may include a set of social network identifiers 450. For example, the DIF 400 may include a first identifier 452 for a first social network (such as Facebook), and a second identifier 454 for a second social network (such as Twitter).

The DIF 400 may include geographic information 460, such as a last known location 462 of one or more of the authorized devices 420. The geographic information 460 may also include a definition of a geographic “fence,” indicating a geographical area in which the subscriber is authorized to conduct transactions. For example, if a transaction originates at a location far away (e.g., 1000 miles) from the subscriber's home location, the transaction may be denied as a possible fraud. The geographic fence 464 may be defined as a distance away from a static or dynamic point, or as a set of coordinates, among other possibilities.

The DIF 400 may also include chronology information 470 that may be used to verify the identity of the subscriber, such as a time 472 at which the subscriber first made a payment associated with the account 430, a time 474 at which the mIdentity associated with the DIF 400 was generated, and a time 476 at which the mIdentity associated with the DIF 400 was last updated.

The DIF 400 may be used across multiple applications to create a highly secure identity connection to authenticate an application or a device. The DIF 400 may be embodied as a computer file that can be dragged and dropped into an application in order to authenticate the user with the application, or in order to authenticate the application with an outside source.

In some embodiments, the DIF 400 may be used in certified devices and/or software. For example, a bank may serve as a certifying agent. Alternatively, a third party designated by a bank may serve as a certifying agent.

The DIF 400 may be particularly useful in conjunction with a credit cache that allows a user to have offline access to payment accounts, even when the user's account and/or the amount of value in the account cannot be immediately verified. As noted above, the DIF 400 may include a credit limit 434 and a payment limit 436, which may be consulted by a mobile device storing the DIF 400 and/or payment systems having a copy of the DIF 400. The DIF 400 may be consulted by these systems when the mobile device is unreachable in order to determine whether a transaction should be carried out. The aforementioned US patent application entitled Methods and Systems for Executing Mobile Currency Transactions (attorney docket no. IBW-003, filed Mar. 17, 2014) describes an exemplary credit cache.

The embodiment depicted in FIG. 4 is intended to be exemplary. A digital identity file according to the present invention may include more or fewer fields than depicted in FIG. 4. The fields in the digital identity file may be application defined (e.g., defined by a mobile financial application such as a mobile wallet) and/or may be user-defined. Values for the various fields may be entered by a user or may be retrieved from external sources such as social networks, financial accounts of the user, credit reporting agencies, a mobile device (e.g., the mobile device's system information and/or GPS system), etc.

### Computer-Implemented Embodiments

Some or all of the exemplary embodiments described herein may be embodied as a method performed in an electronic device having a processor that carries out the steps of the method. Furthermore, some or all of the exemplary embodiments described herein may be embodied as a system including a memory for storing instructions and a processor that is configured to execute the instructions in order to carry out the functionality described herein.

Still further, one or more of the acts described herein may be encoded as computer-executable instructions executable by processing logic. The computer-executable instructions may be stored on one or more non-transitory computer readable media. One or more of the above acts described herein may be performed in a suitably-programmed electronic device.

An exemplary electronic device 500 is depicted in FIG. 5. The electronic device 500 may take many forms, including but not limited to a computer, workstation, server, network computer, quantum computer, optical computer, Internet appliance, mobile device, a pager, a tablet computer, a smart sensor, application specific processing device, etc.

The electronic device 500 described herein is illustrative and may take other forms. For example, an alternative implementation of the electronic device may have fewer components, more components, or components that are in a configuration that differs from the configuration described below. The components described below may be implemented using hardware based logic, software based logic and/or logic that is a combination of hardware and software based logic (e.g., hybrid logic); therefore, components described herein are not limited to a specific type of logic.

The electronic device 500 may include a processor 502. The processor 502 may include hardware based logic or a combination of hardware based logic and software to execute instructions on behalf of the electronic device 500. The processor 502 may include one or more cores 503 that execute instructions on behalf of the processor 502. The processor 502 may include logic that may interpret, execute, and/or otherwise process information contained in, for example, a memory 504. The information may include computer-executable instructions and/or data that may implement one or more embodiments of the invention. The processor 502 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor 502 may include a single core or multiple cores. Moreover, the processor may include a system-on-chip (SoC) or system-in-package (SiP).

The electronic device 500 may include a memory 504, which may be embodied as one or more tangible non-transitory computer-readable storage media for storing one or more computer-executable instructions or software that may implement one or more embodiments of the invention. The memory 504 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

The electronic device 500 may include a virtual machine (VM) 505 for executing the instructions loaded in the memory 504. A virtual machine 505 may be provided to handle a process running on multiple processors 502 so that the process 502 may appear to be using only one computing resource rather than multiple computing resources. Virtualization may be employed in the electronic device 500 so that infrastructure and resources in the electronic device 500 may be shared dynamically. Multiple VMs 505 may be resident on a single electronic device 500.

A hardware accelerator, 506 may be implemented in an ASIC, FPGA, or some other device. The hardware accelerator 506 may be used to reduce the general processing time of the electronic device 500.

The electronic device 500 may include a network interface 508 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 508 may include a built-in network adapter, network interface card, personal computer memory card international association (PCMCIA) network card, card bus network adapter, wireless network adapter, universal serial bus (USB) network adapter, modem or any other device suitable for interfacing the electronic device to any type of network capable of communication and performing the operations described herein.

The electronic device 500 may include one or more input devices 510, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 500 may include other suitable I/O peripherals.

The input devices 510 may allow a user to provide input that is registered on a visual display device 514. A graphical user interface (GUI) 516 may be shown on the display device 514.

A storage device 518 may also be associated with the electronic device 500. The storage device 518 may be accessible to the processor 502 via an I/O bus. Information stored in the storage 518 may be executed, interpreted, manipulated, and/or otherwise processed by the processor. The storage device 518 may include, for example, a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 518 may further store files 420, applications 522, and the electronic device 500 can be running an operating system (OS) 524. Examples of OS may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device 500 and performing the operations described herein. The operating system 524 may be running in native mode or emulated mode.

The storage device 518 may further store logic 526 for generating the mIdentity, logic 528 for calculating the VSIS, authentication logic 530 for providing access to personal information based on the mIdentity and/or VSIS, and any other logic suitable for carrying out the procedures described in the present application. The storage device may also store the DIF 400.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

1. A computer-implemented method of calculating an electronic identity, the method comprising:
receiving a request to create a profile of a subscriber;
obtaining information from the subscriber;
supplementing the obtained information with additional information obtained from a plurality of different sources, the additional information pertaining to a plurality of different categories of information of the subscriber;
storing the obtained information and the additional information together in a storage medium to create an electronic identity structure; and
correlating the obtained information and the additional information to determine a trustworthiness of the electronic identity structure.

2. The method of claim 1, further comprising providing a copy of the electronic identity structure or a measurement of the trustworthiness to a requesting entity.

3. The method of claim 1, further comprising:
receiving an indication of a transaction performed by the subscriber; and
updating the electronic identity structure with information about the transaction.

4. The method of claim 1, wherein the request to create the profile of the subscriber is received from a requesting entity that requests to perform a transaction with the subscriber, and the additional information is obtained with an unrelated entity that does not take part in the transaction.

5. The method of claim 1, wherein the additional information is mobile device information retrieved from a mobile device of the subscriber.

6. The method of claim 1, wherein the additional information is social network information retrieved from a social network account of the subscriber.

7. The method of claim 1, wherein the additional information is electronic marketplace information retrieved from an electronic marketplace account of the subscriber.

8. The method of claim 1, wherein the electronic identity structure comprises a virtual currency flag indicating whether the subscriber is authorized to engage in transactions involving virtual currencies.

9. The method of claim 1, further comprising:
retrieving financial information from the electronic identity structure; and
calculating a credit score from the financial information.

10. The method of claim 1, further comprising:
retrieving risk information from the electronic identity structure; and
calculating an insurance risk from the risk information.

11. The method of claim 1, further comprising generating an insurance policy for guaranteeing the subscriber's identity, wherein a cost of the insurance policy is determined at least in part based on the calculated trustworthiness of the electronic identity structure.

12. An electronic device-readable storage medium storing instructions that, when executed by a processor, cause the processor to:
receive personal information about a subscriber;
organize the information into a hierarchy comprising a first tier of personal information and a second tier of personal information;
providing the first tier of personal information to a requestor;
receiving a request from the requestor to access the second tier of personal information;
retrieving an electronic identity or an electronic identity verification score from the requestor;
evaluating the electronic identity or electronic identity verification score to determine whether to provide the second tier of personal information to the requestor.

13. The medium of claim 12, wherein providing the first tier of personal information comprises broadcasting the first tier of personal information.

14. The medium of claim 12, further storing instructions for assigning a rule to the second tier of personal information, the rule comprising a condition under which the personal information is shareable, and wherein
evaluating the electronic identity or electronic identity verification score comprises comparing the electronic identity or electronic identity verification score to the condition.

15. The medium of claim, further storing instructions for activating a beacon indicating that the first tier of personal information is available for inspection.

16. The medium of claim 12, wherein the electronic identity verification score is calculated based on an amount of information in the electronic identity which is verified or correlated with other information in the electronic identity.

17. The medium of claim 12, wherein the personal information is personal information associated with a social network account, and an amount of the personal information revealed to the requestor varies with the electronic identity verification score.

18. A system comprising:
a storage device for storing an electronic identity file associated with a subscriber, and
a processor programmed with instructions that, when executed, cause the processor to:
retrieve personal information about the subscriber;
retrieve authorized device information associated with one or more of the subscriber's mobile devices;
retrieve account information associated with one or more transaction accounts of the subscriber;
retrieve geographical information pertaining to the subscriber;
retrieve chronology information pertaining to the subscriber; and
assemble the personal information, the authorized device information, the account information, the geographical information, and the chronology information into the electronic identity file.

19. The system of claim 18, wherein the processor further adds a virtual currency flag to the electronic identity file, the virtual currency flag indicating whether the subscriber is authorized to conduct transactions involving a virtual currency.

20. The system of claim 18, wherein the processor further adds social network information to the electronic identity file, the social network information comprising information retrieved from a social network with which the subscriber has an account.
